(19) United States
(12) Patent Application Publication
(10) Pub. No.: US 2017/0211794 A1
(43) Pub. Date: Jul. 27, 2017

(54) A LIGHTING SYSTEM

(71) Applicant: 3M INNOVATIVE PROPERTIES COMPANY, St. Paul, MN (US)

(72) Inventors: Sheldon B. Ruiz, Singapore (SG); Andrew T. Tio, Singapore (SG); Chong Yang Ong, Singapore (SG); Kar Yam Tay, Singapore (SG); Karl J. L. Geisler, St. Paul, MN (US); David G. Freier, St. Paul, MN (US)

(73) Assignee: 3M INNOVATIVE PROPERTIES COMPANY, St. Paul, MN (US)

(21) Appl. No.: 15/328,188

(22) PCT Filed: Aug. 21, 2015
(86) PCT No.: PCT/US2015/046231

§ 371 Date: Jan. 23, 2017

(30) Foreign Application Priority Data
Aug. 24, 2014 (SG) 10201405166T

(51) Int. Cl. F21V 29/503; F21V 5/00; F21V 29/83; F21V 23/00; F21V 7/22; F21V 29/74

(52) U.S. Cl. CPC F21V 29/503; F21V 7/22; F21V 29/74; F21V 29/83; F21V 23/009; F21V 5/005; F21Y 2115/10

(57) ABSTRACT

A lighting system comprising a light engine, a duct connected to the light engine defining a light transport passage for transporting light emitted from the light engine along a propagation direction through the duct, one or more light output surfaces on the duct through which light is emitted, the light engine comprising arranged sequentially in a single file: a light collimator having an output end arranged to face the light transport passage, a LED light source arranged to direct light into an input end of the light collimator, and a heat sink thermally coupled to the LED light source.

### FIELD OF TECHNOLOGY

The invention relates to lighting systems, and more particularly to ducted lighting systems that employ a light engine in which components are arranged in a single file.

### BACKGROUND

The long-distance transport of visible light can be facilitated by mirror-lined light ducts and is employed in architectural lighting to deliver light throughout the interior parts of buildings. Mirror-lined ducts also provide advantages of large cross-sectional area and large numerical aperture (enabling larger fluxes with less concentration), a robust and clear propagation medium (that is, air) that leads to both lower attenuation and longer lifetimes, and a potentially lower weight per unit of light flux transported. Mirror-lined light ducts can be uniquely enabled by the use of 3M optical films, including mirror films such as enhanced specular reflector (ESR) films that have greater than 98% specular reflectivity across the visible spectrum of light.

Concurrently, LEDs are increasingly deployed as an energy saving replacement for traditional tungsten or fluorescent lighting systems. Lamps installed with LEDs typically have LEDs mounted on a plate, which is in turn affixed on a wall or ceiling, and the LEDs are arranged directly behind the light output surface of the lamp. LED lighting systems that use LED strips for a large room may consequently require installation of a plurality of LED strips throughout the room, along with sizeable driver circuit units for powering the LEDs. Heat generated by individual LED units on the strip requires effective dissipation to avoid overheating which could affect the lifespan of the LED units, but limited space exists in lighting systems, such as mirror-lined light ducts, to implement effective heat dissipation devices.

Given the myriad of competing factors such as those described above influencing the design of lighting systems and the ever increasing stringency end users place on both cost and performance, the need continues to exist for innovative approaches in developing new solutions.

### SUMMARY OF INVENTION

In one aspect, the present disclosure provides a lighting system that comprises a light engine, a duct connected to the light engine defining a light transport passage for transporting light emitted from the light engine along a propagation direction through the duct, and one or more light output surfaces on the duct through which light is emitted. The light engine comprises, arranged sequentially in a single file, a light collimator having an output end arranged to face the conduit, a LED light source arranged to direct light into an input end of the light collimator, and a heat sink thermally coupled to the LED light source, respectively.

This and other aspects of the invention are described in the detailed description below. In no event should the above summary be construed as a limitation on the claimed subject matter which is defined solely by the claims as set forth herein.

### BRIEF DESCRIPTION OF THE DRAWINGS

Throughout the specification, reference is made to the appended drawings, where like reference numerals designate like elements, wherein:

FIG. 1 shows a cross sectional view of a lighting system with one light engine.

FIG. 2 shows a cross sectional view of a lighting system with two light engines.

FIG. 3 shows a cross sectional view of a lighting system with one light engine and one bend in the duct.

FIG. 4 shows a cross sectional view of a lighting system with two light engines and two bends in the duct.

FIG. 5 shows a cross-sectional view of a light engine

FIG. 6 shows a perspective view of a light engine.

FIG. 7 is a perspective view of a light collimator.

FIG. 8 is a perspective view of a light engine housing.

FIG. 9 is a top view of a duct section,

FIG. 10 is a perspective view of a heat sink

FIG. 11 is a perspective view of the multilayer optical stack of the output surface of a duct section.

FIG. 12 is a cross sectional view of the multilayer optical stack of the output surface of a duct section.

FIG. 13 is a cross sectional view of a lighting system wherein the light output surface comprises mirrors.

FIG. 14 is a cross sectional view of a lighting system having modular construction, comprising light engine, light collimation module and ducts.

FIG. 15 is a cross sectional view of a lighting system in which the light collimator comprises a plurality of light collimators arranged together.

FIG. 16 shows a 2 by 2 layout of light collimators in a square duct.

The figures are not necessarily drawn to scale. However, it will be understood that the use of a numeral to refer to a component in a given figure is not intended to limit the component in another figure labeled with the same number

### DETAILED DESCRIPTION

The present disclosure describes a lighting system in which a light duct is coupled to a light engine having components assembled sequentially in a single file, namely, the light collimator, LED light source and, heat sink, and in certain embodiments, the driver circuit, are sequentially arranged. By arranging the components of the light engine in this manner, the distribution of heat was optimized while enabling the light engine to adopt an appearance visually similar to the light duct. It was found that the light engine was able to operate for long periods of time without damaging the collimator or the LED driver circuitry in this manner.

The present specification is not limited to the specific examples or data set forth herein. The embodiments disclosed herein are capable of being made, practiced, used, carried out and/or formed in various ways expected of a skilled person in the field once an understanding of the invention is acquired. Numerical indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “for example”) provided herein, is intended merely to better illustrate the invention and does not pose a limitation on the scope of the invention unless otherwise claimed. No language in the specification, and no structures shown in the drawings, should be construed as indicating that any non-claimed element is essential to the practice of the invention. The use herein of the terms “including” “comprising” or “having” and permutations thereof, is meant to encompass the features defined thereafter and equivalents thereof, as well as additional items.

Recitation of ranges of values herein are intended to refer individually to each separate value falling within the range, unless otherwise indicated herein, and each separate value is incorporated into the specification as if it were individually recited herein. For example, if a compositional range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

Unless otherwise stated, reference to any document herein does not constitute an admission that any of these documents forms part of the common general knowledge in the art.

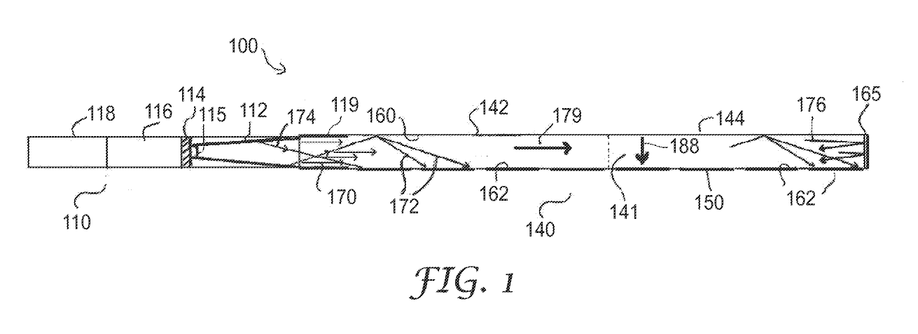

Referring to FIG. 1, a lighting system 100 is shown in which light engine 110 is connected to a duct 140. Light engine 110 comprises a light collimator 112, which has one end facing duct 140, and another end facing the LED light source 114. LED light source 114 is arranged to direct light into the input end of the light collimator, so that light exiting the light collimator 112 and entering the duct 140 is substantially collimated. LED light source 114 is thermally coupled to a heat sink 116, which helps to dissipate heat generated from the LED light source 114 during operation. For example, the LED light source 114 may be mounted onto a surface of the heat sink 116. Thermal interface materials, also known as heat sink compounds or thermal grease, may be used to provide improved thermal coupling between the LED light source 114 and the heat sink 116. LED light source 114 may comprise an LED array 115 arranged on a surface of heat sink 116. As can be seen in FIG. 1, the components of the light engine are arranged sequentially in a single file. In an exemplary embodiment, the heat sink has the shape of a rectangular cuboid, the longest dimension of the rectangular cuboid, i.e. the length, being configured to extend away from the collimator 112. In this manner, exposure of heat sensitive parts of the collimator to the heat generated by the LED array 115 is reduced due to the conduction of heat in an axial direction away from the LED array 115 along the length of the heat sink 116.

The duct 140 defines a light transport passage 141. The duct 140 may be made up of 1, 2, 3, 4, 5 or more duct sections. Each duct section may be attached onto the ceiling or wall via nails or adhesive, or via fastening clips, and are coupled to each other via fastening clips or alternatively, each duct section may comprise mating end portions so that one duct section can be telescopically fitted to another duct section. Any other means of coupling duct sections together can also be used, where preferably the adjoining surfaces are well-fitting and do not suffer from light leaks.

FIG. 1 shows duct 140 comprising individual duct sections 142, 144. The internal surface of each duct section 142, 144 is lined with a reflective material 160 to help reflect light within the duct 140. Examples of usable reflective materials include polished metal surfaces or specialty materials such as 3M Enhanced Specular Reflective (ESR) films. Of the light rays that exit the light collimator 112, a substantial amount comprises collimated light rays 170. Non-collimated light rays 172 may be derived from light rays that are reflected off the internal surfaces of duct 140, or light rays 174 that are reflected off the surface of the light collimator 112. Light is hence propagated longitudinally through the duct, or in other words, light is transported along a propagation direction, as represented by arrow 179, that is parallel to the longitudinal axis of the duct.

Light exits the duct 140 via light output surfaces 150 located on the duct's surface. In one embodiment, each light output surface is arranged in a plane parallel to the longitudinal axis of the duct. Light therefore exits the duct in a direction, as represented by arrow 188, that is transverse to its propagation direction 179. Optical right angle films, such as 3M Transmissive Right Angle Films II (TRAF) may be used for this purpose. Advantageously, a single LED light source may be used to illuminate a duct ranging from several meters long to several tens of meters long, or preferably about ten duct sections of 1.2 meters each, i.e. total of 12 meters. Light rays 176 arriving at the end of the duct 140 are reflected off surface 165 and are recycled.

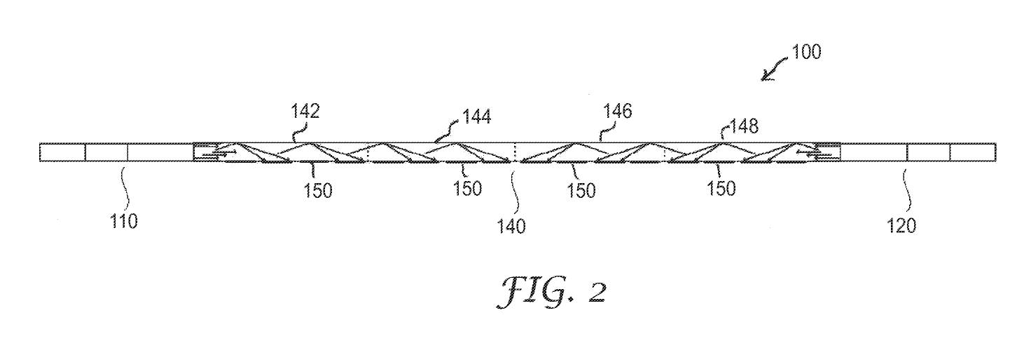

FIG. 2 shows an embodiment in which lighting system 102 comprises two light engines, wherein light engine 120 is arranged at an opposing end of the duct 140, opposite light engine 110. In this configuration, duct 140 may comprise a plurality of duct sections 142, 144, 146, 148. The provision of two light engines is advantageous for illuminating a long duct, which may in various instances be 20 meters, 30 meters, or more in length, or in certain embodiments, about 20 duct sections of 1.2 meters, i.e. 24 meters. This embodiment may be useful for illuminating long corridors or passageways.

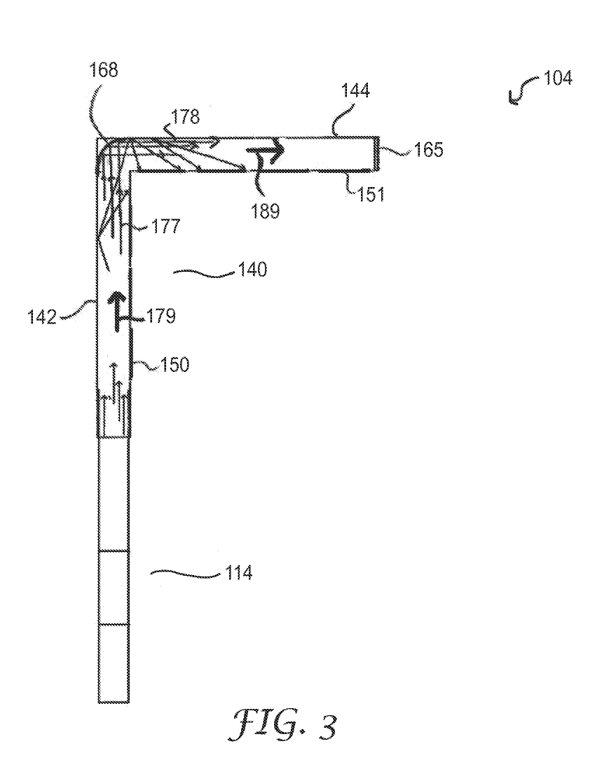

FIG. 3 shows an embodiment in which lighting system 104 comprises a bend 168 which alters the propagation direction of light in the duct 140. Bend 168 enables light to be propagated in a second direction which is different from the original propagation direction as indicated by arrow 179. In FIG. 3, duct 140 comprises duct section 144 arranged perpendicular to duct section 142. Bend 168 comprises a reflective surface, such as a mirror, in order to reflect light into a new propagation direction. Light rays 177 are reflected off bend 168, and subsequently enter duct section 144 as light rays 178, propagating in a new direction as represented by arrow 189. Light rays eventually exit duct section 144 via light output surface 151. If vertically oriented, the lighting system may function as overhead lighting, potentially replacing street lamps and household lamps.

FIG. 4 is an extension of the embodiment shown in FIG. 3. The lighting system 106 comprises two bends 168, 169 and two light engines 110, 120. Light from light engine 110 is propagated from light duct section 142 to 144, 146 and 148, whereas light from light engine 120 is propagated from light duct section 148 to 146, 144 and 142.

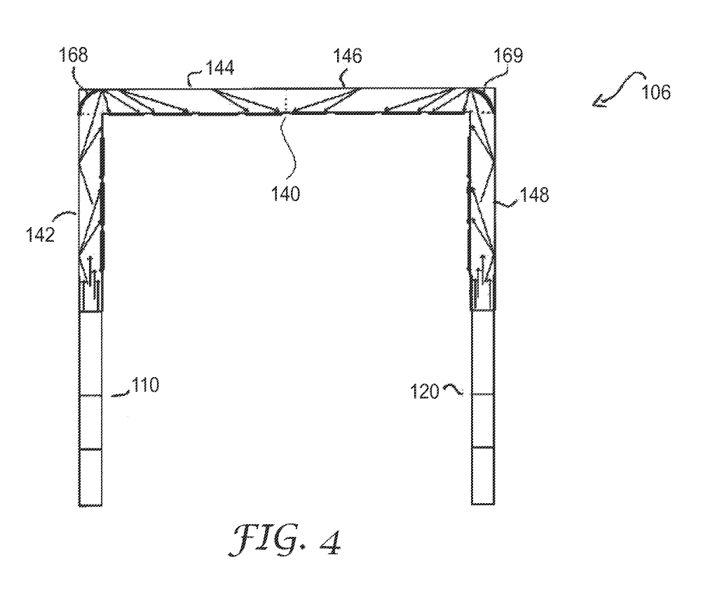

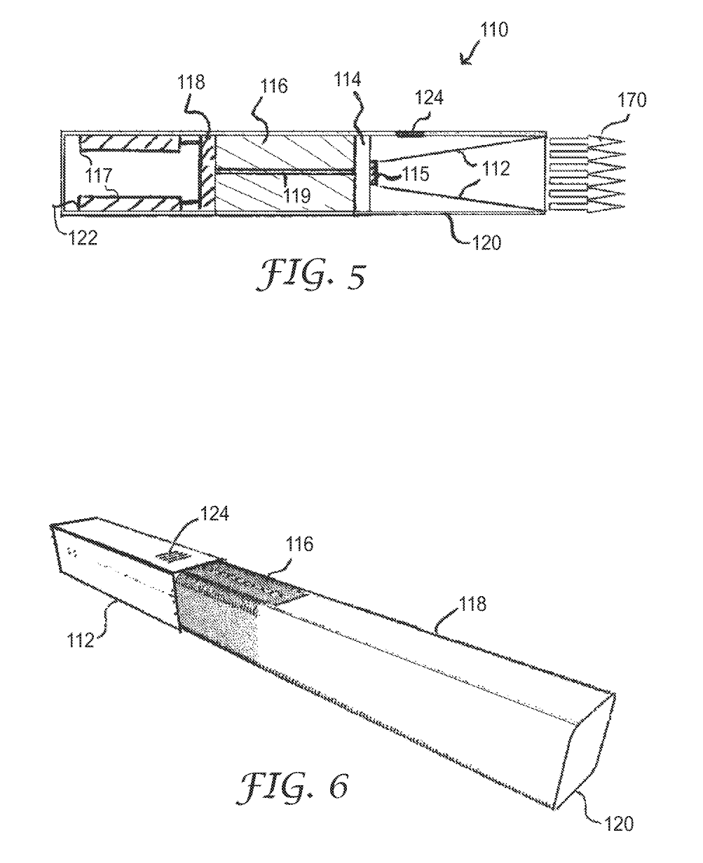

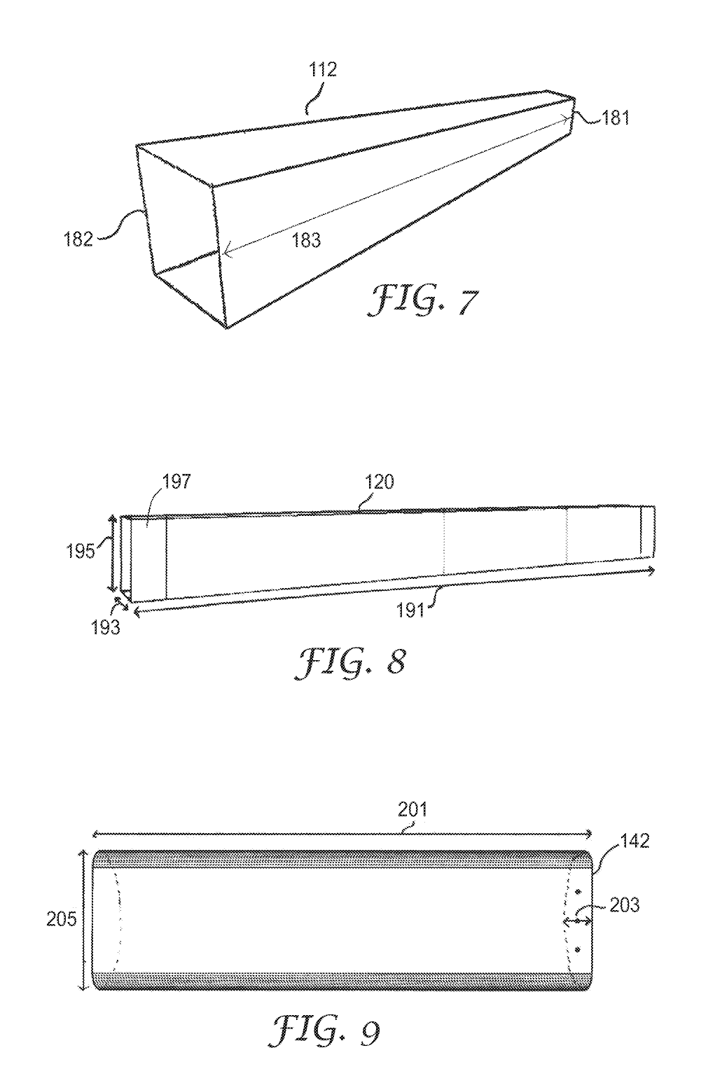

FIG. 5 and FIG. 6 are close-up views of the light engine 110. Light collimator 112 is used to collimate light produced by the LED light source 114. In some embodiments, the light collimator 112 is configured in the shape of a conical or a pyramidal frustum, sometimes referred to as a reflective cone or pyramid. In other words, it is configured as a cone or pyramid structure in which the pointed end is removed, thereby having an opening 181 that serves as the input end of the light collimator and is attached to the heat sink. The large opening 182 serves as the output end for collimated light to exit. FIG. 7 shows an example of a light collimator in the form of a conical frustum.

LED light source 114 may comprise an LED array 115 and a driver circuit 118 for powering the LED array. In the embodiment shown in FIG. 5, LED array 115 is arranged on a first surface of the heat sink 116, and a driver circuit 118 for powering the LED array is arranged or sandwiched on a second surface of the heat sink, so that the driver circuit 118 is separated from the LED array 115 by the heat sink 116. Wiring 119 extends from the driver circuit 118 to the LED array 115. The light engine may be enclosed in a light engine housing 120. The driver circuit or sub-components thereof may also be placed on the light engine housing 120 at positions 117. Wiring 122 serves to connect the driver circuit to an external electrical source. By arranging the component of the light engine 110 in this manner, heat generating components of the light engine 110 are optimally separated from each other, as well as separated from the duct 140 and collimator 112, each of which may comprise heat sensitive optical films. This arrangement may be helpful for high power LED arrays which can generate sufficient heat to damage the wiring and components of the driver circuit 118 if placed in close proximity. The driver circuit may furthermore heat generating components, imposing an additional thermal load on the heat sink. Hence, positioning driver circuit 118 away from the LED array 115 may further optimize the heat distribution across the light engine 110.

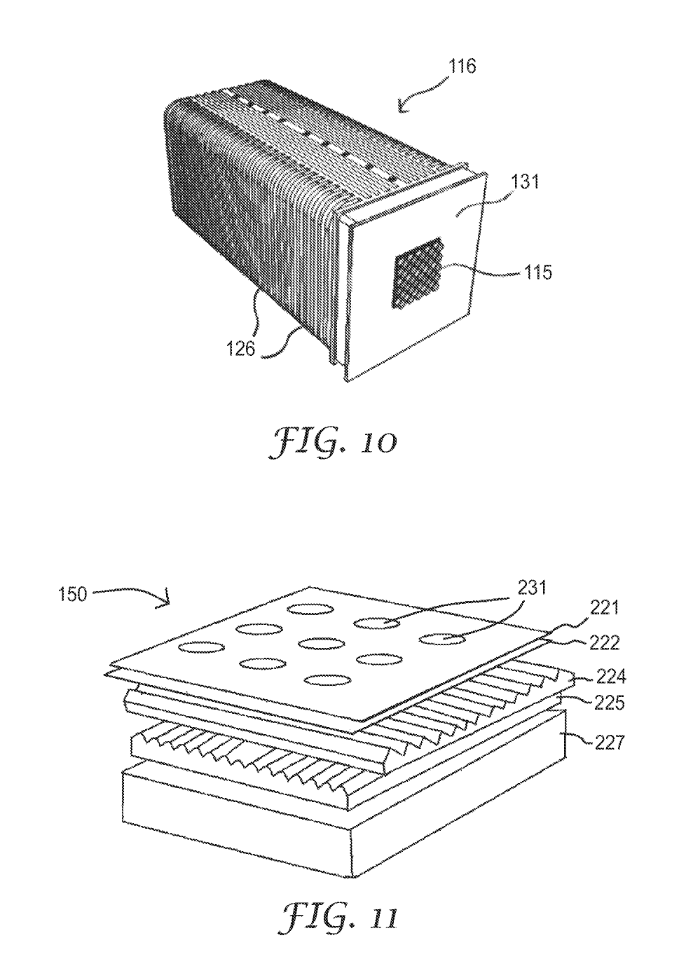

In order to increase the surface area for heat dissipation, the light engine housing may comprise in an exemplary embodiment a metal casing that is thermally coupled to the heat sink 116, to enable the entire light engine housing to function as a heat sink of sorts. In some embodiments, the light engine housing may be configured as a secondary heat sink, to aid in the cooling of heat sink 116. Optionally, the heat sink 116 may comprise grooves 126 as shown in FIG. 10. It may comprise fins that are exposed outside of the metal casing to enable increased cooling of the heat sink. The light engine housing 120 may furthermore be provided with slots 124 to enable hot air to escape, hence further cooling the light engine.

In order to provide the light engine 110 with an appearance that is similar to the duct—a desirable goal from an aesthetic perspective—at least one of the length, depth or width of the light engine housing 120, as represented by arrows 191, 193, 195 in FIG. 8 comprises the same dimension as that of, respectively, the length, depth or width of the duct sections, as shown by arrows 201, 203, 205 in FIG. 9. In addition, the light engine housing 120 may be painted or provided with decorative elements similar to that used for the duct. In this manner, the light engine housing 120 appears similar to the duct sections, giving a more uniform external appearance. In architectural lighting, where visual aesthetic qualities of lighting systems are an important consideration in the design of a building or a room, the single file arrangement of the light engine components enables visual similarity to be achieved, avoiding an overall unaesthetic appearance in which the light engine looks conspicuously different from the light duct. In this embodiment, the portion of the light engine housing 120 for enclosing the light collimator is provided with an extended portion 197 to enable it to be matingly fitted into a duct section.

LED array 115 may be a 3×3, 4×4, 5×5, or 6×6 LED array or any other size or configuration, delivering in various instances, a total of 5000, 10000, or 15000 or more lumens of light per LED array. As shown in FIG. 10, the LED array 115 is arranged on a surface 131 of the heat sink 116, which may be a polished, white or reflective surface to help recycle light. In certain embodiments, the dimensions of an LED array may be 15 mm×15 mm, 20 mm×20 mm, 25 mm×25 mm, or 30 mm×30 mm. Larger LED arrays may be used as well.

The following design rules for the light engine yielded favorable performance in the operation of the lighting system:

Size of the LED array=A×B

Area of output end of light collimator=(3A×3B)

Collimator length=12×B

where A and B represents the dimensions of the edge of a square or rectangular LED array. To achieve a uniform appearance for the light engine and duct, the cross section of the duct may be designed to correspond to the same shape and size of the output end of the light collimator. Accordingly, it has roughly the dimensions of 3A×3B, and may be a square or a rectangle. Notwithstanding the above, a duct with circular or elliptical cross section may also be used if the light collimator has the shape of a conical frustum.

### Example 1

Taking an LED array that is 25 mm×25 mm in size as an example, the above design rule requires the area of the input end of the light collimator to be about 25 mm×25 mm in size. Correspondingly, the output end of the light collimator is designed to be 75 mm×75 mm in size. The length of the light collimator may be designed to be 300 mm. Since each duct is about 1.2 meters in length, in order for the light engine housing 120 to have the same length, the heat sink and driver circuit portion of the light engine may set to about 900 mm in length.

### Example 2

Taking an LED array that is 25 mm×25 mm in size as an example, the above design rule requires the area of the input end of the light collimator to be about 25 mm×25 mm in size. Correspondingly, the output end of the light collimator is designed to be 75 mm×75 mm in size. The length of the light collimator may be designed to be 360 mm. Since each duct is about 1.2 meters in length, in order for the light engine housing 120 to have the same length, the heat sink and driver circuit portion of the light engine may set to about 840 mm in length.

### Example 3

Taking an LED array that is 15 mm×15 mm in size as an example, the above design rule requires the area of the input end of the light collimator to be about 15 mm×15 mm in size. Correspondingly, the output end of the light collimator is designed to be 45 mm×45 mm in size. The length of the light collimator may be designed to be about 180 mm. Since each duct is about 1.2 meters in length, in order for the light engine housing 120 to have the same length, the heat sink and driver circuit portion of the light engine may set to about 102 mm in length.

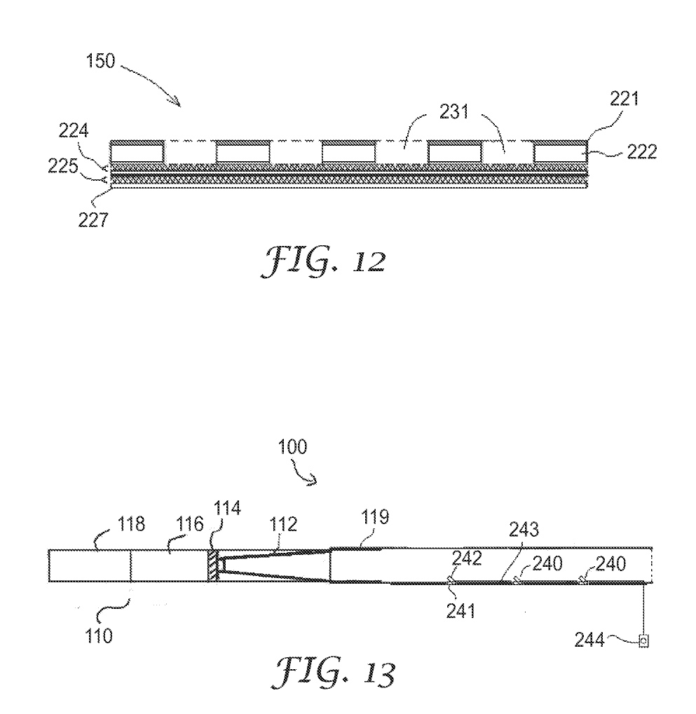

FIGS. 11 and 12 show, respectively, a perspective view and a cross sectional view of the layer structure of a light output surface 150 of a duct section according to an embodiment. In this embodiment, the light output surface 150 comprises a reflective layer arranged to face the duct, the reflective layer having one or more perforations for transmitting light, a polished metal substrate layer having one or more perforations aligned to the perforations of the reflective layer, and one or more optical films arranged over the perforations for processing light leaving the duct. In general, the light output surface performs the dual function of extracting light from the duct, and recycling the remaining light back into the duct for further transmission. For this purpose, the inner most layer may comprise a perforated reflective sheet 221. Commercially available examples include 3M Vikuiti™ Enhanced Specular Reflectors. Perforated reflective sheet 221 is laminated on a polished metal layer 222 comprising corresponding perforations 231 aligned to the perforations of the reflective sheet 221. An example of the polished metal layer comprises an aluminum layer, which is lightweight and capable of being polished. The aluminum layer acts as a support substrate and also provides a suitably reflective surface for reflecting light. Light leaves the output surface 150 via perforations 231. The polished metal layer is attached, via suitable optical adhesives, such as 3M Optically Clear Adhesive 8211/8212/8213/8214/8215 to name a few examples, to a light turning film 224. Light turning films are commercially available as the 3M Vikuiti™ Turning Films series, comprising microreplicated prismatic films for redirecting light toward a direction substantially transverse to the propagation direction 179 as shown in FIG. 1. A specific example is the 3M Transmissive Right Angle Film II (TRAF). Light turning film 224 is in turn attached to a light steering film 225 which may be selected from birefringent films or polarizing films. Optionally, a protective sheet may be provided beneath light turning film 224. This embodiment provides a low cost alternative to conventional optical film stacks that require the use of polycarbonate substrates, which in some cases may cost up to 40% of the bill of materials for an optical plate. This embodiment also provides the benefits of better optical performance, particularly in terms of transmittance as exiting light passes through a thinner optical film stack, and less costly manufacturing since the lamination of optical adhesives to a polycarbonate sheet is avoided.

Further embodiments of the invention with respect to (i) the light output surface (ii) the duct, (iii) modular construction, and (iv) the light collimator, are described in the following paragraphs.

### Light Output Surface.

To provide a low cost light output surface with adequate light output performance, it may be preferable to form the light output surface using individual optical film components that are suited to the desired performance. A plurality of light output surfaces may be present on a duct, each light output surface comprising one or more optical films. For example, to achieve good brightness, the light output surface may comprise a brightness enhancement film. A commercially available example is the 3M Vikuiti™ Brightness Enhancement Film (BEF), which is an optical film with prismatic structures microreplicated throughout the film to increase reflection and refraction of light rays. A reflective polarizer film may be used. A commercial example is the 3M Vikuiti™ Dual Brightness Enhancement Film (DBEF). Different layer arrangements of BEF and DBEF may be used: one may deploy an individual layer of BEF for the light output surface, or an individual layer of DBEF, or a plurality of BEF layers, or a plurality of DBEF layers, or a combination of BEF and DBEF layers. Additionally, light diffuser films may be used in conjunction with BEF and DBEF films to diffuse incident light from a light source. Commercially available examples include 3M™ Envision™ Diffuser Films 3735-50 or 3735-60. For structural support, each optical film layer or multi-layer film stack may be affixed on transparent glass or polycarbonate or other equivalent transparent substrate. 3M Optically Clear Adhesive may optionally be used; mechanical fastening of individual optical layers may be done as an alternative; or the margins of the optical film layer contacting the substrate may simply be provided with double sided adhesive tape without interfering with light transmission through the optical layer. An alternative to the use of a transparent substrate is to have the optical film layer stiffened by forming an outer layer of polyethylene terephthalate (PET), or biaxially oriented polypropylene film (BOPP), or cast polypropylene on the optical film.

Alternative to the use of optical films for the light output surface is the use of reflectors, e.g. conventional mirrors. In one embodiment, the duct comprises a plurality of light output surfaces, each light output surface comprising a mirror capable of being actuated to a position in which light transmitted through the duct is incident on the mirror and reflected out of the duct. Mirror may be mounted at each light output surface and may be mechanically actuated to reflect light out of the duct. The mirrors may be tilted at any desired angle to reflect light out of the light duct. Referring to FIG. 13, mirrors 240 may be mounted on a hinge at each light output surface. The mirrors may be in a closed position 241 when lights are not in use, or in an open position 242 when lights are in use, wherein the mirror is tilted to reflect incident light out of the duct. The mirrors may be connected by connecting rods 243 to a central control knob 244 to be manually actuated between open and close positions. Optionally, an electronic motor may be used to actuate the mirrors. The mirrors may be arranged in a staggered layout (e.g. alternate left and right along the duct), and optionally with larger mirrors (with increasing distance away from the light source) to provide uniform light output at each light output surface.

### Duct.

The duct may comprise a plurality of light output surfaces. In some embodiments, the light output surface is located on either one or a combination of the bottom surface, top surface or lateral surface of the duct relative to its mounted position. Light output surfaces may be located not only at the bottom surface (opposite the surface facing the wall) of the duct, but may also be located on lateral sides of the duct. In some embodiments, sections of the duct may comprise a transparent material e.g. polycarbonate, or a white or colored translucent material, e.g. cast acrylic plexiglass, depending on the aesthetic considerations of the application.

### Modular Construction.

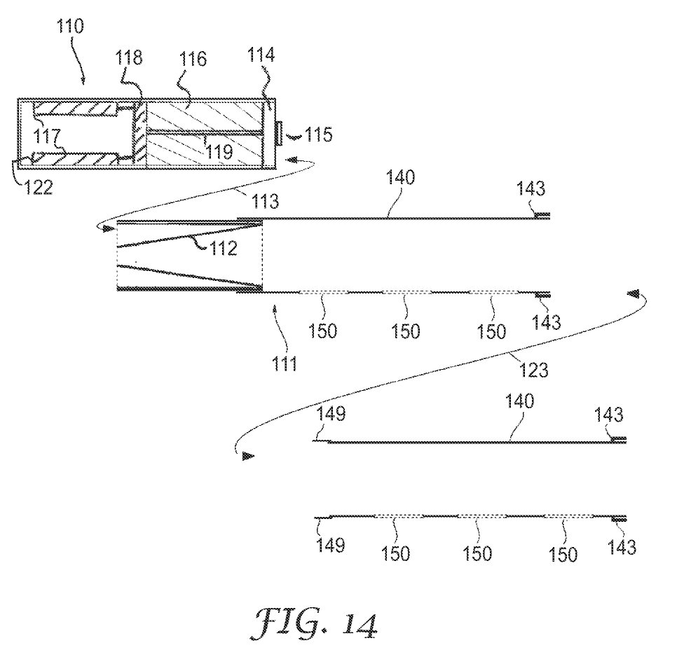

In some embodiments, the light engine, duct and the collimator are made separately as modules, to be assembled during installation. As shown in FIG. 14, the light collimator 112 and the duct 140 comprising light output surfaces 150 may be produced separately from the light engine 110. The light collimator 112 and the duct 140 may form a light collimation module 111, and is fitted onto the light engine 110 in accordance with arrows 113. Another duct 140 is fitted to the connector module in accordance with arrows 123. In order to ensure mating fit between sections, the light collimation module 111 and each duct 140 may be provided with a sleeve 143 at one end, and a flared section 149 at the other end. The sleeve 143 is designed to have a mating fit with the flared section 149 of the subsequent duct, thus enabling each duct to be coupled to the next duct readily. Snap-on fixtures, bolts and nuts, or latches, or any other securing means, may also be added (not shown) to enable ducts to be securely fastened to each other. This embodiment advantageously prevents light leak at the junctions of each duct as well. Manufacturing the entire lighting system in this modular fashion also facilitates the logistical aspects of manufacturing.

### Light Collimator.

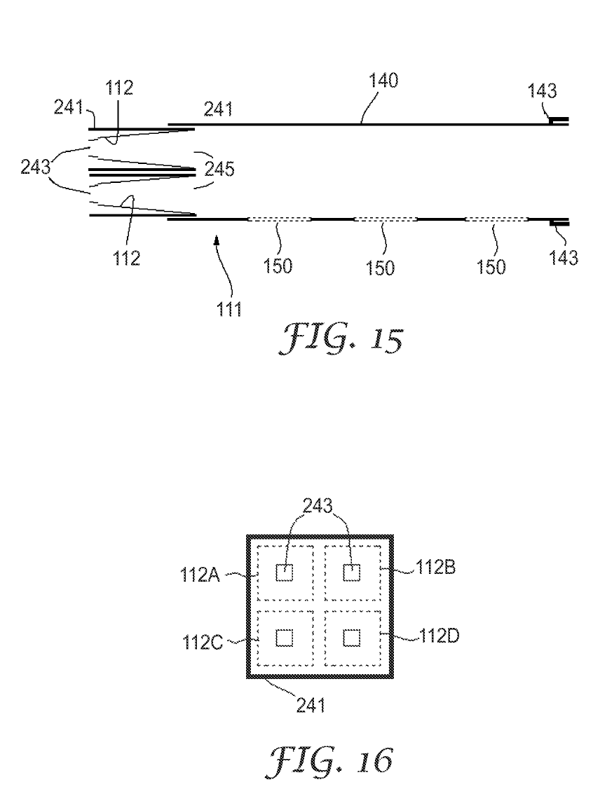

FIG. 15 shows a collimator module 111 in which a plurality of separate light collimators 112 arranged together. Advantageously, for a given duct size, the use of a plurality of smaller light collimators bundled together enables a shorter light collimator to be used to achieve a more compact shape. Any suitable number of light collimators, such as 2, 4, 6 or 9 (or preferably n×n) light collimators, may be combined in this manner to achieve a shorter light collimator configuration without sacrificing performance. Light entry surface 243 is fitted over light engine 110, and duct 140 is fitted over light output surface 245. FIG. 16 shows a top view of a bundled light collimator in which 4 light collimators (112A, 112B, 112C and 112D) are arranged in a 2×2 layout within a square shaped duct 241.

Although the present invention has been described with particular reference to preferred embodiments illustrated herein, it will be understood by those skilled in the art that variations and modifications thereof can be effected and will fall within the scope of this invention as defined by the claims thereto now set forth herein below.

1. A lighting system comprising:
a light engine, a duct connected to the light engine defining a light transport passage for transporting light emitted from the light engine along a propagation direction through the duct, one or more light output surfaces on the duct through which light is emitted, the light engine comprising arranged sequentially in a single file:
a light collimator having an output end arranged to face the light transport passage,
a LED light source arranged to direct light into an input end of the light collimator,
and
a heat sink thermally coupled to the LED light source.

2. The lighting system of claim 1, wherein light emitted from the light engine is transported along a propagation direction parallel to the longitudinal axis of the duct, and exits the duct in a direction that is transverse to said propagation direction.

3. The lighting system of claim 1, wherein the LED light source comprises an array of LEDs arranged on a first surface of the heat sink, and a driver circuit for powering the LEDs arranged on a second surface of the heat sink.

4. The lighting system of claim 1, wherein the light engine is enclosed in a light engine housing.

5. The lighting system of claim 4, wherein the light engine housing is thermally coupled to the heat sink and configured as a secondary heat sink.

6. The lighting system of claim 4, wherein at least one of the length, depth or width of the duct and the light engine housing have the same dimension.

7. The lighting system of claim 1, wherein the light collimator comprises a pyramidal or conical frustum.

8. The lighting system of claim 1, wherein the duct comprises one or more bends, each bend defining a light transport passage for transporting light in a second propagation direction.

9. The lighting system of claim 1, wherein a second light engine is connected to an opposing end of the duct.

10. The lighting system of claim 1, wherein the duct comprises a plurality of light output surfaces, each light output surface comprising a multilayer optical stack comprising
a reflective layer arranged to face the duct, said reflective layer having one or more perforations for transmitting light,
a polished metal substrate layer having one or more perforations aligned to the perforations of the reflective layer, and
one or more optical films arranged over the perforations for processing light leaving the duct.

11. The lighting system claim 1, wherein the duct comprises a plurality of light output surfaces, each light output surface comprising one or more optical films.

12. The lighting system of claim 10, wherein the optical films are selected from light turning films, polarizing films, reflective polarizing films, brightness enhancement films, and diffuser films.

13. The lighting system of claim 1, wherein the duct comprises a plurality of light output surfaces, each light output surface comprising a mirror capable of being actuated to a position in which light transmitted through the duct is incident on the mirror and reflected out of the duct.

14. The lighting system of claim 1, wherein the light output surface is located on either one or a combination of the bottom surface, top surface or lateral surface of the duct relative to its mounted position.

15. The lighting system of claim 1, wherein the duct has a circular or rectangular cross section.

16. The lighting system of claim 1, wherein a plurality of ducts are connected together, each duct comprises a sleeve section at one end and a flared section at the other end, the sleeve section of each duct capable of mating connection with the flared section of another duct.

17. A light collimation module comprising a light collimator coupled to a duct, the light collimation module being part of a lighting system comprising:
a light engine, a duct connected to the light engine defining a light transport passage for transporting light emitted from the light engine along a propagation direction through the duct, one or more light output surfaces on the duct through which light is emitted, the light engine comprising:
the light collimator having an output end arranged to face the light transport passage,
a LED light source arranged to direct light into an input end of the light collimator, and
a heat sink thermally coupled to the LED light source,
said light collimator, LED light source and heat sink arranged sequentially in a single file.

18. The light collimation module of claim 17, wherein the light collimator comprises a plurality of separate light collimators arranged together.

19. The light collimation module of claim 17, wherein the duct comprises a plurality of light output surfaces, each light output surface comprising one or more optical films selected from light turning films, polarizing films, reflective polarizing films, brightness enhancement films, and diffuser films.

20. The light collimation module of claim 1, wherein the duct's internal surface is provided with a reflective material.
